(19) United States
(12) Patent Application Publication
(10) Pub. No.: US 2018/0313571 A1
(43) Pub. Date: Nov. 1, 2018

(54) UNIT FOR THE NATURAL VENTILATION OF A ROOM, PROVIDED WITH A SOUND ABSORBER

(71) Applicants: Christian CARME, Marseille (FR); TECHNOFIRST, Aubagne (FR)

(72) Inventor: Christian CARME, Marseille (FR)

(21) Appl. No.: 15/772,892

(22) PCT Filed: Nov. 2, 2016
(86) PCT No.: PCT/FR2016/052838

§ 371 Date: May 2, 2018

(30) Foreign Application Priority Data
Nov. 2, 2015 (FR) 1560494

(51) Int. Cl. F24F 13/18; F24F 13/24; G10K 11/178; E06B 7/10

(52) U.S. Cl. CPC F24F 13/18; F24F 13/24; G10K 11/178; G10K 2210/3044; F24F 2013/247; F24F 2221/20; E06B 7/10

(57) ABSTRACT

An apparatus for natural ventilation of a room, with a room delimited by walls. At least one door or one window includes a fixed stationary frame surrounding a movable opening frame, a ventilation passage provided on the door or the window and which communicates between the outside of the room and the inside of the room in such a way as to allow natural ventilation between the outside and inside of said room, and a noise absorber capable of attenuating sound waves propagating in the ventilation passage, the attenuation being realized by the generation of a counter-noise which is superimposed on the sound waves or by absorbing all or part of said sound waves.

### TECHNICAL FIELD OF THE INVENTION

The invention has for object a unit for the natural ventilation of a room, provided with a sound absorber. The invention also relates to a ventilation passage suitable for providing natural ventilation between the outside and the inside of a room.

It relates to the technical field of particular arrangements that make it possible to provide natural ventilation of a room through a door or a window.

### Prior Art

It is known through patent documents US2014/0113541 (DRIER), U.S. Pat. No. 6,648,750 (WISEMAN) and WO 2004/070155 (HARDING), ventilation assemblies for buildings comprising a ventilation passage installed on a door or a window.

This ventilation passage communicates between the outside of the building and the inside of said building in such a way as to allow natural ventilation between the outside and the inside of said building. More precisely, it has a first end, closed by a trapdoor and opening into the building, and a second end opening to the outside of said building.

In the WISEMAN apparatus, a noise absorber is installed in this ventilation passage in order to reduce the noise. The absorber comprises at least one control microphone installed to sense the noise in the ventilation passage, and at least one loudspeaker provided with a vibrating membrane suitable for generating a counter-noise in the ventilation passage in response to the noise sensed by the control microphone.

The WISEMAN apparatus has several disadvantages. First of all, it is necessary to provide a trapdoor in order to free the first end of the ventilation passage and initiate natural ventilation. The manipulation and the access to this trapdoor are not necessarily easy for certain people, in particular the elderly. Furthermore, this trapdoor can be the source of a heat loss detrimental to the insulation of the building.

Furthermore the apparatus is complex to realize and to install. Indeed, the ventilation passage is either installed in the opening frame of the door or of the window, or between the stationary frame and a bearing wall. It is therefore necessary to provide substantial modifications on the opening frames of the door or of the window and/or a bearing structure for the setting up of the ventilation passage.

The invention aims to overcome this situation. In particular, an objective of the invention is to simplify the design of the ventilation passage as well as the manipulation thereof.

Another objective of the invention is to reduce the risks of a heat leak at the ventilation passage.

Yet another objective of the invention is to simplify the setting up of the ventilation passage.

### DISCLOSURE OF THE INVENTION

The solution proposed by the invention is an apparatus for natural ventilation of a room, said apparatus comprising:

a room delimited by walls,

at least one door or one window installed in one of the room walls and comprising a fixed stationary frame surrounding an opening frame supporting a glass panel,

a ventilation passage provided on the door or the window and which communicates between the outside of the room and the inside of the room in such a way as to allow natural ventilation between the outside and inside of said room,

a noise absorber capable of attenuating sound waves propagating in the ventilation passage, the attenuation being realized by the generation of a counter-noise which is superimposed on said sound waves,

the opening frame is mounted movably in the stationary frame between:
a closed position in which the opening frame is hermetically integral with the stationary frame in such a way as to prevent any ventilation between the inside and outside of the room by the door or the window,
and an open position wherein the open frame is detached and separated from the opening frame in such a way as to allow natural ventilation between the inside and outside of the room by the door or the window.

This installation is remarkable in that:

the ventilation passage is delimited by at least one fixed wall and at least one movable wall, said fixed wall being integral with the stationary frame or with the wall and said movable wall being integral with the opening frame,

the fixed wall and the movable wall are configured in such a way that:
when the opening frame is in the closed position, the movable wall and the fixed wall are in an arrangement that hermetically seals the ventilation passage and that prevents any ventilation between the inside and outside of the room by said ventilation passage,
when the opening frame is in the intermediate open position, the movable wall and the fixed wall are in an arrangement that frees the ventilation passage and that allows natural ventilation between the inside and outside of the room only by said ventilation passage.

It is therefore now by simply and directly manipulating the door or the window, that the user can allow or prevent the ventilation through the ventilation passage. In addition, it is no longer necessary to provide a trapdoor as in the WISEMAN apparatus, which simplifies the design of the ventilation passage. Furthermore, the fixed and movable walls hermetically closing the ventilation passage, heat losses are reduced, and even zero, at this level.

Other advantageous characteristics of the invention are listed hereinbelow. Each one of these characteristics can be considered alone or in combination with the remarkable characteristics defined hereinabove, and be the object, where applicable, of one or several divisional patent applications:

Advantageously, the fixed wall and the movable wall are formed by plates fixed respectively on the opening frame and on the stationary frame, said walls having inner faces which are located in the ventilation passage, at least one of these faces being covered partially or entirely with a sound-insulating material.

The ventilation passage can have a first end opening into the room and a second end opening to the outside of said room; the fixed wall and the movable wall being configured in such a way that when the opening frame is in the closed position, the fixed wall closes the first end of the ventilation passage.

The ventilation passage can have a first end opening into the room and a second end opening to the outside of said room; the fixed wall and the movable wall being configured in such a way that when the opening frame is in the closed position, the movable wall closes the second end of the ventilation passage.

According to an embodiment, the fixed wall is integral with the stationary frame or with the wall and is formed by a profile that has a cross-section in the shape of an L of which one of the branches forms a base integral with a profile of said stationary frame; the movable wall is symmetrical with the fixed wall, said movable wall is integral with the opening frame and is formed by a profile that has a cross-section in the shape of an L of which one of the branches forms a base integral with a profile of said opening frame.

According to another embodiment, the fixed wall has the form of a flat plate integral with a profile of the stationary frame, said plate extending in a vertical plane which is in the extension of the glass panel, towards the latter; the movable wall has the form of a flat plate integral with a profile of the opening frame, said plate extending in a vertical plane which is in the extension of the glass panel, opposite the latter.

The plate forming the fixed wall and the inner wall of the glass panel are advantageously in the same plane, said plate covering said inner wall when the opening frame is in the closed position. And the plate forming the movable wall and the outer wall of the glass panel can be in the same plane, said plate covering the outer wall of the wall when the opening frame is in the closed position.

The movable wall and the fixed wall of the ventilation passage can be separated from one another, with this separation remaining constant from the closed position to the intermediate open position of the opening frame.

The movable wall and the fixed wall can be configured in such a way that when the opening frame is in the closed position, said movable wall is in tight contact with said fixed wall over most of the length of said fixed wall, in such a way that the ventilation passage is hermetically closed.

When the opening frame is in the intermediate open position, the movable wall is advantageously separated from the fixed wall, in such a way that the ventilation passage is freed.

When the opening frame is in the intermediate open position, the ventilation passage preferably has the shape of a chicane.

The opening frame is advantageously formed by profiles surrounding at least one glass panel, which opening frame is mounted able to slide in the fixed stationary frame, which stationary frame is provided with at least one rail whereon is displaced at least one of the profiles of said opening frame.

This rail is advantageously provided with an element forming an abutment when the opening frame is in the intermediate open position.

Another aspect of the invention relates to a ventilation passage suitable for providing natural ventilation between the outside and the inside of a room. This passage is remarkable in that:

the ventilation passage is delimited by at least one fixed wall and at least one movable wall, said fixed wall comprising means for fastening suitable for being attached to a stationary frame of a door or of a window or to a wall of the room and said movable wall comprising means for fastening suitable for being attached to a movable opening frame of said door or of said window, which fixed wall and which movable wall are configured in such a way that:

in a close-together position, the movable wall and the fixed wall are in an arrangement that prevents any ventilation by the ventilation passage,

in a separated position, the movable wall and the fixed wall are in an arrangement that allows natural ventilation only by the ventilation passage.

### DESCRIPTION OF THE FIGURES

Other advantages and characteristics of the invention shall appear when reading the following description of a preferred embodiment, in reference to the annexed drawings, realized by way of indicative and non-limiting examples and wherein:

FIG. 1 is a front view, from the inside of the room, of an apparatus in accordance with the invention according to a first embodiment, with the window in the closed position,

FIG. 2 is a diagrammatical view as a cross-section according to A-A of the apparatus of FIG. 1,

FIG. 3 is an enlargement of the arrangement of the fixed and movable walls diagrammed in FIG. 2,

FIG. 4 is a front view, from the inside of the room, of the apparatus according to the first embodiment, with the window in the intermediate open position,

FIG. 5 is a diagrammatical view as a cross-section according to B-B of the apparatus of FIG. 4,

FIG. 6 is an enlargement of the arrangement of the fixed and movable walls diagrammed in FIG. 5,

FIG. 7 is a front view, from the inside of the room, of an apparatus in accordance with the invention according to a second embodiment, with the window in the closed position,

FIG. 8 is a diagrammatical view as a cross-section according to C-C of the apparatus of FIG. 7,

FIG. 9 is a front view, from the inside of the room, of the apparatus according to the second embodiment, with the window in the intermediate open position,

FIG. 10 is a diagrammatical view as a cross-section according to D-D of the apparatus of FIG. 9,

FIG. 11 shows an embodiment and an arrangement of an active noise absorber,

FIG. 12 shows another embodiment and an arrangement of an active noise absorber,

FIG. 13 is a cross-section diagrammatical view of an apparatus in accordance with the invention according to a third embodiment, with the window in the closed position,

FIG. 14 shows the apparatus of FIG. 13 with the window in the intermediate open position,

FIG. 15 shows an embodiment and an arrangement of a passive noise absorber.

### PREFERRED EMBODIMENTS OF THE INVENTION

This invention relates to an apparatus for natural ventilation of a room, which is characterized by a particular design of the ventilation passage and of the noise absorber that it comprises.

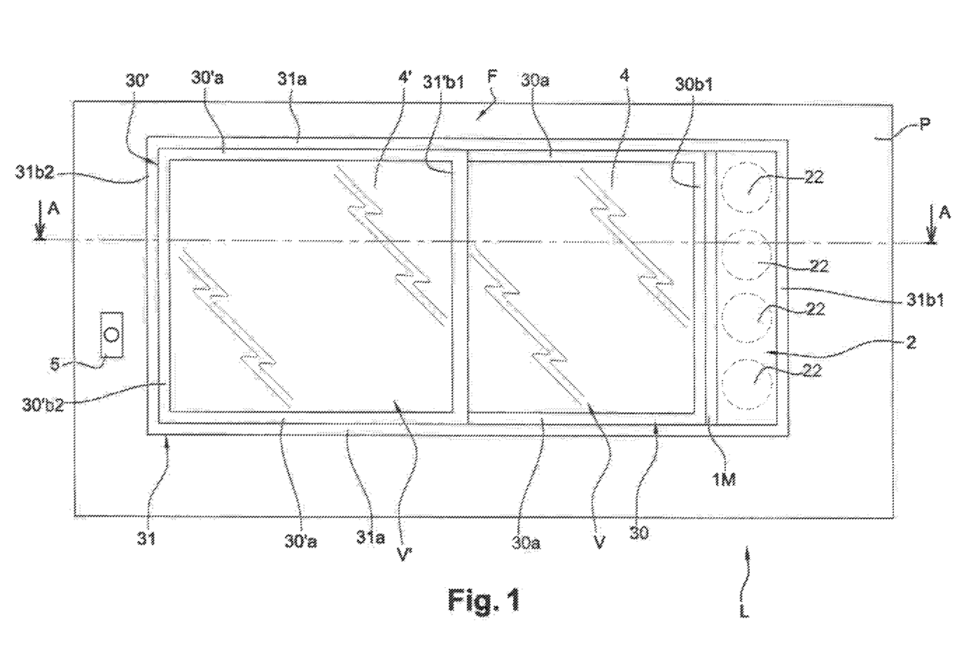

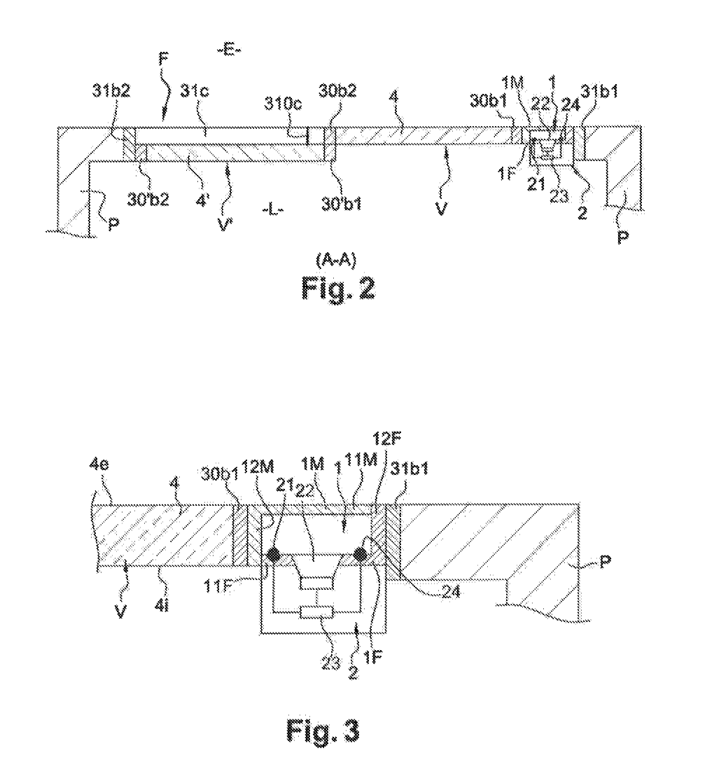

In relation to FIGS. 1 and 2, the apparatus comprises a room L delimited by walls P. This room can be a room in a residence or an office. In this case, the walls P are typically bearing walls.

At least one door or one window F is installed in one of the room L walls P. In order to simplify the understanding of the invention, the rest of the description focuses only on a window F.

This window F is preferably a multi-glazed window, for example double glazing, but can be with single glazing. It forms an interface between the inside of the room L and the outside of said room.

The window F itself is of a known type. It is comprised of one or several leaves V, V′ as shown in FIG. 1. Each leaf V, V′ is comprised of an opening frame 30, 30′ (simply referred to as “opening” in carpentry) formed by horizontal 30a, 30′a and vertical 30b1, 30b2, 30′b1, 30′b2 profiles surrounding at least one glass panel 4, 4′. The opening frames 30, 30′ have a general rectangular shape, which borders the respective panels 4, 4′ according to the four sides thereof. They are more preferably identical.

The opening frames 30, 30′ are mounted movable in a stationary frame 31 (simply referred to as “stationary” in carpentry) fixed to the wall P. This stationary frame 31 is integral with the wall P and more generally with the structural work or with the frame of the assembly where the window must be arranged F. It is also formed by horizontal 31a and vertical 31b1, 31b2 profiles surrounding the opening frames 30, 30′.

In the case where the opening is formed of two leaves V, V′, the dimensions of the opening frames 30, 30′ in width are substantially equal to half of that of the stationary frame 31 that surrounds them. Their dimensions in height are substantially equal to that of the stationary frame 31, to the nearest profile thicknesses. By way of an illustrative example only, the opening frames 30, 30′ have a width of 1.5 m and a height of 2.5 m.

The profiles 30a, 30′a, 30b1, 30b2, 30′b1, 30′b2, 31a, 31b1, 31b2 are rigid, made from metal such as aluminum or other, wood, plastic material, even by combining such materials.

In the example of FIGS. 1 and 2, the window F is a sliding window. At least the leaf V is able to be displaced by laterally sliding over at least one horizontal support rail 31c mounted in the stationary frame 31, and in particular in its lower portion. The opening frame 30 can include one or several wheel or roller carriages, able to provide the sliding thereof in the rail 31c.

Conventionally, the opening frame 30 is movable between a closed position (FIGS. 1 and 2) wherein it closes the stationary frame 31 and an open position wherein it frees. More particularly, in the closed position, the opening frame 30 is hermetically attached to the stationary frame 31 in such a way as to prevent any ventilation between the inside and outside E the room L by the door or the window F. And in the open position, the opening frame 30 is detached and separated from the opening frame 31 in such a way as to allow natural ventilation between the inside and outside E the room L by the door or the window F. In the closed position, the two leaves V, V′ are in the extension of one another, while in the open position they are superimposed.

In prior art, in the closed position, the lateral vertical profile 30b1 of the opening frame 30 generally penetrates into the corresponding vertical profile 31b1 of the stationary frame 31, with these two profiles being hermetically attached. Preferably, these two profiles 30b1, 31b1 include mutual means of locking for blocking the leaf V in this position. Typically, in the closed position, no ventilation between the inside and outside E the room L, is possible by the window F. In the open position, the lateral vertical profile 30b1 of the opening frame 30 is detached from the corresponding vertical profile 31b1 of the stationary frame 31, and is separated from the latter by a predetermined distance (for example between 2 cm and 15 cm, preferably 10 cm) when the leaf V slides. Natural ventilation is possible between the inside and outside E the room L, by the window F.

A ventilation passage 1 is installed at the window F. This passage 1 is a piece of equipment that is combined with the window 1, without it being necessary to modify the design of the latter. This passage 1 can therefore be installed on an existing window F which is already placed in a wall P.

The passage 1 communicates between the outside E of the room L and the inside of said room in such a way as to allow, where applicable, natural ventilation between the outside E and inside of said room. The manner in which this ventilation is made possible is explained hereinafter in the description.

In the embodiment of FIGS. 1, 2, 3, 4, 5, 6, 11 and 12, the passage 1 is delimited by at least one fixed wall 1F and at least one movable wall 1M.

The fixed wall 1F is integral with the stationary frame 31 or with the wall P. It is preferably integral with the vertical profile 31b1 of the stationary frame 31. It is formed by a profile of the corner or angle type, and has a cross-section in the shape of an L.

In FIGS. 3, 11 and 12, one of the branches 12F of the fixed wall 1F, advantageously the smallest, forms a base which is attached to the vertical profile 31b1 of the stationary frame 31. This attaching is carried out by any suitable means of fastening, in particular by screwing, snap-fitting, or gluing. In FIGS. 11 and 12, holes 120F are provided for a fastening by screws. The branch 12F forming the base has a width corresponding to that of the vertical profile 31b1. Its length corresponds to that of the vertical profile 31b1 in such a way that it extends over the entire height of the window F.

The other branch 11F of the fixed wall 1F, advantageously the largest, extends perpendicularly to the branch 12F, in a vertical plane which is in the extension of the glass panel 4, towards the latter. The width of the branch 11F is for example between 5 cm and 30 cm. In FIGS. 1 and 2, the branch 11F and the inner wall 4i of the glass panel 4 are in the same plane, this inner wall which is understood as the one which is located inside the room L.

The movable wall 1M is the exact symmetry of the fixed wall 1F. It is integral with the opening frame 30, preferably integral with the vertical profile 30b1 of the opening frame 30. It is also formed by a profile of the corner or angle type, and has a cross-section in the shape of an L.

In FIGS. 3, 11 and 12, one of the branches 12M of the movable wall 1M, advantageously the smallest, forms a base which is attached to the vertical profile 30b1 of the opening frame 30. This attaching is carried out by any suitable means of fastening, in particular by screwing, snap-fitting, or gluing. In FIGS. 11 and 12, holes 120M are provided for a fastening by screws. The branch 12M forming the base has a width corresponding to that of the vertical profile 30b1. Its length corresponds to that of the vertical profile 30b1 in such a way that it extends over the entire height of the window F.

The other branch 11M of the movable wall 1M, advantageously the largest, extends perpendicularly to the branch 12M, in a vertical plane which is in the extension of the glass panel 4, opposite the latter. The width of the branch 11M is equal to that of the branch 11F of the fixed wall 1F. In FIGS. 1 and 2, the branch 11M and the outer wall 4e of the glass panel 4 are in the same plane, this outer wall 4e is understood as the one which is located to the outside E of the room L.

The fixed wall 1F and the movable wall 1M are both made from metal such as aluminum, stainless steel or other, wood, plastic material, glass or plexiglas in order to be transparent, even by combining such materials. In order to simplify the design, these walls 1F and 1M are advantageously formed of sheets folded or curved at a right angle.

In the embodiment of FIGS. 1, 2, 3, 4, 5, 6, 11 and 12, the fixed wall 1F and the movable wall 1M are therefore interposed between the lateral vertical profile 30b1 of the opening frame 30 and the corresponding vertical profile 31b1 of the stationary frame 31. The two branches 11M and 11F are located in two parallel vertical planes which are separated from one another by a distance corresponding to the width of the branches 12M and 12F forming bases, to the nearest thicknesses.

When the opening frame 30 is in the closed position, the walls 1F and 1M are close together. The free end of the branch 11M comes into contact with the branch 12F and the free end of the branch 11F comes into contact with the branch 12M. As such, the fixed wall 1F and the movable wall 1M are arranged in such a way as to form a vertical duct with a rectangular or square section, with this duct delimiting the ventilation passage 1. The vertical duct delimited by the fixed wall 1F and by the movable wall 1M being closed on each one of the faces thereof, the ventilation passage 1 is hermetically closed in such a way that any ventilation between the inside and outside E the room L is prevented including any ventilation by said passage.

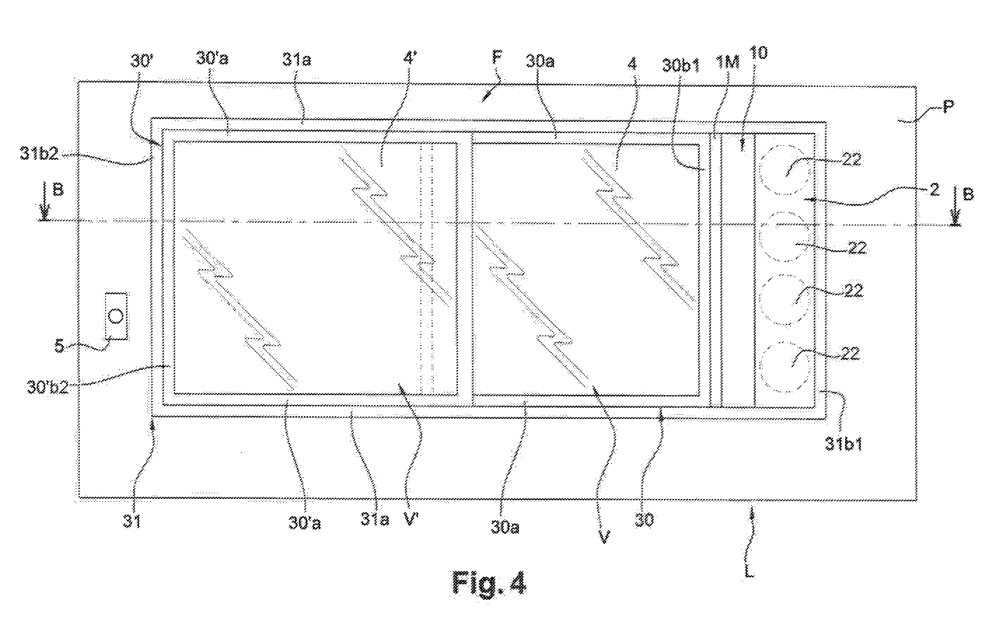

In an intermediate open position shown in FIGS. 4, 5 and 6, the leaf V slides in such a way that the movable wall 1M moves away from the fixed wall 1F by a predetermined distance. More particularly, the free end of the branch 11M moves away from the branch 12F and the free end of the branch 11F moves away simultaneously by the same distance from the branch 12M. This predetermined distance, which corresponds to the sliding distance of the leaf V from the closed position to the intermediate open position, is for example between 2 cm and 15 cm, preferably 10 cm.

In this intermediate open position, the ventilation passage 1 has a first end 10 that opens into the room L and a second end 12 that opens to the outside E of said room. They are located in two parallel planes but are separated from one another by a distance corresponding to the width of the branches 11M and 11F. The passage 1 is as such in the shape of a chicane, with this configuration improving the ventilation.

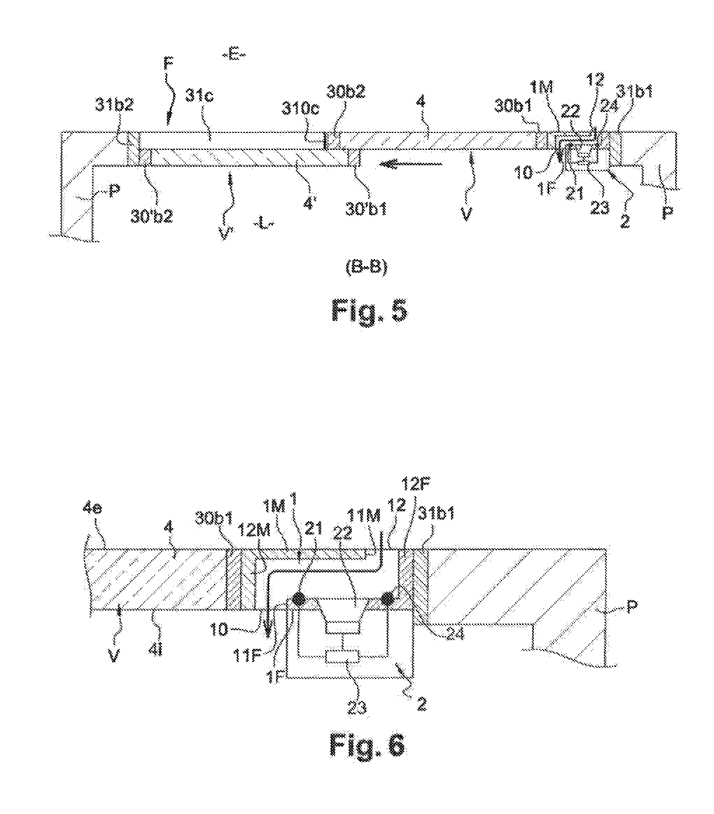

In relation to FIGS. 4, 5 and 6, the first end 10 is delimited on the one hand by the free end of the branch 11F of the fixed wall 1F, and on the other hand by the branch 12M of the movable wall 1M. In the same way, the second end 12 is delimited on the one hand by the free end of the branch 11M of the movable wall 1M, and on the other hand by the branch 12F of the fixed wall 1F. The movable wall 1M and the fixed wall 1F are therefore in an arrangement that frees the ventilation passage 1 and that allows natural ventilation between the inside and outside E the room L by said ventilation passage, between the two ends 10 and 12. This ventilation is diagrammed in FIG. 6, by the arrow drawn in the passage 1.

As such, in the closed position, the fixed wall 1F and the movable wall 1M respectively close the first end 10 and the second end 12 of the ventilation passage 1 and free them in the intermediate open position.

The first end 10 and the second end 12 extend vertically along the window F, over a length corresponding substantially to that of the vertical profiles 30b1, 30b2. In this way, the ventilation can be realized over the entire length of the window F.

The ventilation passage 1 can be formed of several channels superimposed parallel one above the other. These various channels are independent and are for example delimited by horizontal plates or sheets integral with the movable wall 1M or with the fixed wall 1F, and which are installed between the two branches 11M and 11F. This tiered design provides a homogeneous distribution of the flow of air ventilated over the entire length of the window F. This design furthermore allows the noise absorber 2 to operate over a wider frequency band between 50 Hz and 2000 Hz, preferably between 70 Hz and 1700 Hz. Indeed, the smaller the section of the channels is, the greater the maximum frequency is that can be attenuated the noise absorber 2. By way of example, each channel can be of a square, rectangular or circular section. The length of their diagonal of their diameter is for example between 5 cm and 10 cm.

The width of the openings 10 and 12 corresponds to the sliding distance of the leaf V from the closed position to the intermediate open position, for example between 2 cm and 15 cm. Advantageously, this width corresponds to the distance separating the two branches 11M and 11F in such a way as to reduce the turbulences of the flow of air in the ventilation passage 1, and therefore the sound level of said flow. In the configuration of FIGS. 1 to 6, given that the movable wall 1M and the fixed wall 1F have the same dimensions, the openings 10 and 12 have the same width. It can however be considered that these openings 10 and 12 have different widths, by providing branches 11M and 11F that do not have the same width. In this case, only the end 10 or the end 12 is closed in the closed position.

In FIGS. 4, 5 and 6, the intermediate open position is reached when the width of the ends 10 and 12 of the ventilation passage corresponds to the distance that separates the two branches 11M and 11F. So that the user can easily reach this position without opening any further the leaf V, it is advantageously provided to install in the rail 31c, an element 310c forming an abutment when the opening frame 30 is in the intermediate open position. This element 310c is clearly visible in the FIGS. 2 and 5 and has for example the form of a rib made of elastomer installed in the rail 31c. When the user wishes to open the leaf V further, it is sufficient for the user to slide said leaf with a moderate effort, in such a way that this rib made from elastomer is retracted under the opening frame 30.

When the opening frame 30 is in the open position, i.e. displaced beyond the intermediate open position (by a distance that is greater than the aforementioned predetermined distance), natural ventilation between the inside and outside E the room L is realized in the same way as a conventional open door or window.

In the embodiment of FIGS. 1, 2, 3, 4, 5, 6, 11 and 12, when the opening frame 30 is in the closed position, the vertical profiles 30b1 and 31b1 are not directly attached due to the fact that the movable wall 1M and the fixed wall 1F are interposed between these two profiles.

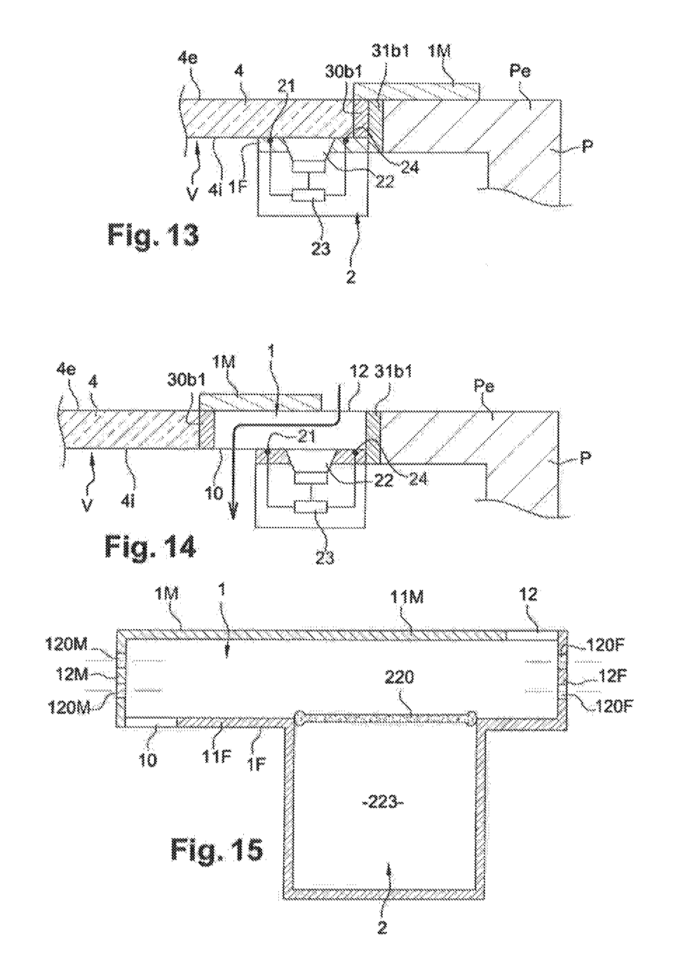

FIGS. 13 and 14 show an alternative embodiment wherein the vertical profiles 30b1 and 31b1 can be attached when the opening frame 30 is in the closed position.

The fixed wall 1F has the form of a flat plate integral with the vertical profile 31b1 of the stationary frame 31. This plate is attached to the vertical profile 31b1 of the stationary frame 31 by all suitable means of fastening, in particular by screwing, snap-fitting, or gluing. Its length corresponds to that of the vertical profile 31b1 in such a way that it extends over the entire height of the window F. The plate 1F extends in a vertical plane which is in the extension of the glass panel 4, towards the latter. The width of the plate 1F is for example between 5 cm and 30 cm. In FIGS. 13 and 14, the plate 1F and the inner wall 4i of the glass panel 4 are in the same plane, said plate covering said inner wall when the opening frame 30 is in the closed position.

The movable wall 1M is similar to the fixed wall 1F. It is integral with the opening frame 30, preferably integral with the vertical profile 30b1 of the opening frame 30. It is also formed by a flat plate. This plate is attached to the vertical profile 310b1 of the opening frame 30 by all suitable means of fastening, in particular by screwing, snap-fitting, or gluing. Its length corresponds to that of the vertical profile 30b1 in such a way that it extends over the entire height of the window F. The plate 1M extends in a vertical plane which is in the extension of the glass panel 4, opposite the latter. The width of the plate 1M corresponds to that of the plate 1F. In FIGS. 13 and 14, the plate 1M and the outer wall 4e of the glass panel 4 are in the same plane, said plate covering the outer wall Pe of the wall P when the opening frame 30 is in the closed position.

As described above, the fixed wall 1F and the movable wall 1M are both made from metal such as aluminum, stainless steel or other, wood, plastic material, glass or plexiglas in order to be transparent, even by combining such materials.

In FIG. 13, in the closed position, the fixed wall 1F and the movable wall 1M cover respectively the wall P and of the glass panel 4, in such a way that the vertical profiles 30b1 and 31b1 can be attached. In this configuration, the ventilation passage 1 is hermetically closed, with no ventilation between the inside and outside E the room L able to take place, including any ventilation by said passage.

In the intermediate open position shown in FIG. 14, the leaf V slides in such a way that the movable wall 1M moves away from the wall P and extends beyond the vertical profile 31b1 of the stationary frame 31 by a predetermined distance for example between 2 cm and 15 cm, preferably 10 cm. Simultaneously, the vertical profile 30b1 of the opening frame 30 moves away from the movable wall 1M and also extends beyond it by the same distance.

In this intermediate open position, the ventilation passage 1 is formed. It is delimited by the two walls 1F and 1 M which are separated from one another by a distance corresponding to that of the vertical profile 30b1 of the opening frame 30. The ventilation passage 1 furthermore has the first end 10 that opens into the room L and the second end 12 that opens to the outside E of said room, these two ends being arranged in such a way that the passage 1 is in the shape of a chicane.

More particularly, the first end 10 is delimited on the one hand by the free end of the fixed wall 1F, and on the other hand by the vertical profile 30b1 of the opening frame 30. In the same way, the second end 12 is delimited on the one hand by the free end of the movable wall 1M, and on the other hand by the vertical profile 31b1 of the stationary frame 31. The movable wall 1M and the fixed wall 1F are therefore in an arrangement that frees the ventilation passage 1 and that allows natural ventilation between the inside and outside E the room L only by said ventilation passage, between the two ends 10 and 12. This ventilation is diagrammed in FIG. 14 by the arrow drawn in the passage 1.

In the embodiments of FIGS. 1, 2, 3, 4, 5, 6, 11, 12, 13 and 14, the movable wall 1M and the fixed wall 1F are separated from one another by a distance corresponding to the thickness of the vertical profile 30b1 of the opening frame 30. This separation remains constant from the closed position to the intermediate open position.

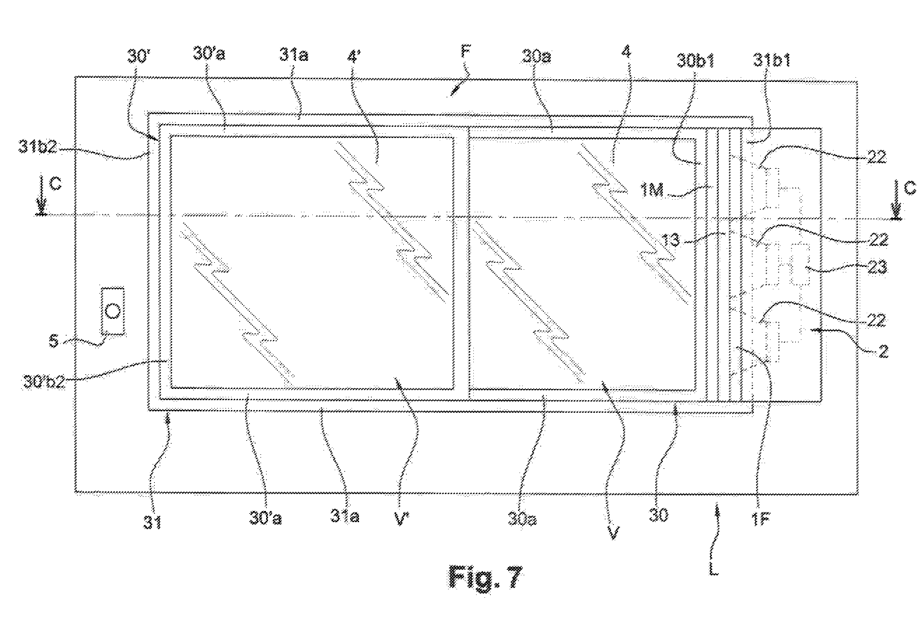

FIGS. 7 to 10 show another embodiment wherein the glass panel 4 is not partially closed by the fixed wall 1F and/or the movable wall 1M, contrary to the embodiments described hereinabove. Indeed, in the embodiment of FIGS. 1, 2, 3, 4, 5, 6, 11 and 12, the fixed wall 1F and the movable wall 1M are arranged in the space that separates the vertical profile 31b1 from the vertical profile 30b1, which is able to reduce the total glazed surface of the window F and therefore the lighting of the room L. And in the embodiment of FIGS. 113 and 14, in the closed position, the fixed wall 1F partially covers the glass panel 4, reducing as such the glazed surface.

In FIGS. 7 to 10, the fixed wall 1F and the movable wall 1M are respectively formed by a profile of the corner or angle type, and have a cross-section in the shape of an L. They are both made from metal such as aluminum, stainless steel or other, wood, plastic material, glass or plexiglas in order to be transparent, even by combining such materials. In order to simplify the design, these walls 1F and 1M are advantageously formed of sheets folded or curved at a right angle.

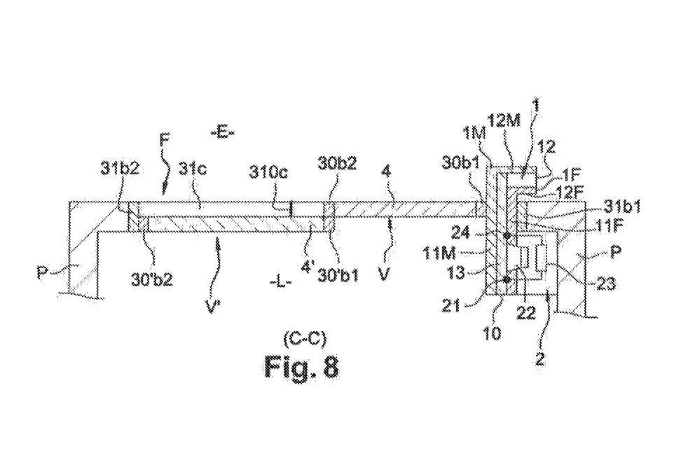

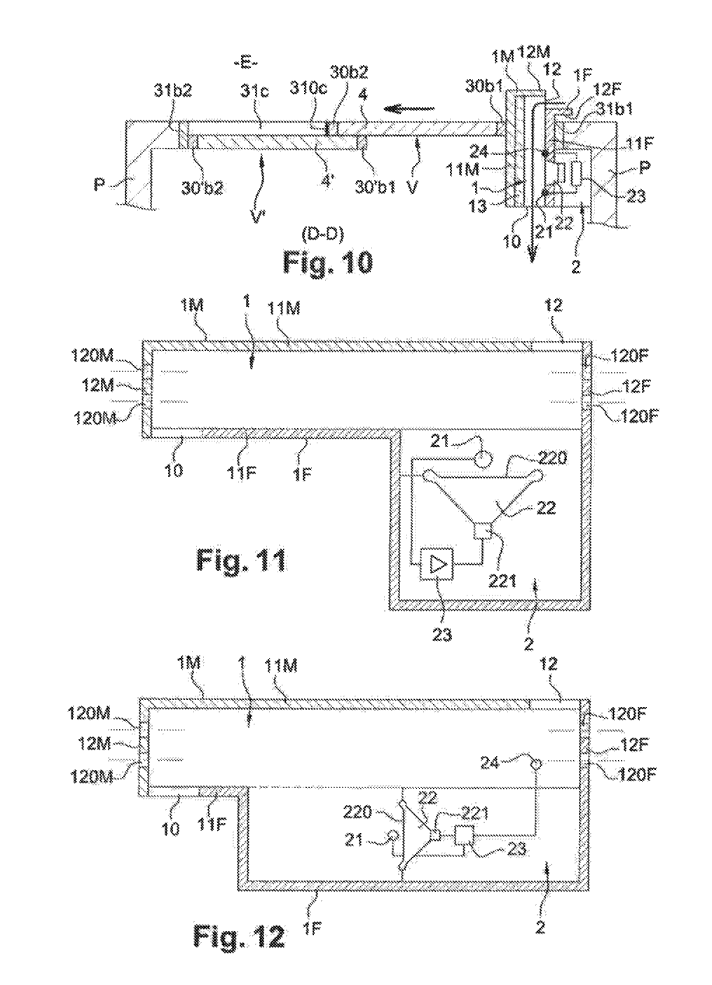

In FIGS. 8 and 10, one of the branches 11F of the fixed wall 1F, advantageously the largest, forms a base which is attached to the vertical profile 31b1 of the stationary frame 31. This attaching is carried out by any suitable means of fastening, in particular by screwing, snap-fitting, or gluing. The branch 11F forming the base is located in a vertical plane which is perpendicular to the plan of the window F and of the stationary frame 31. It has a width greater than that of the vertical profile 31b1, for example between 5 cm and 30 cm, in such a way that it extends inside and outside E the room L. Its length corresponds to that of the vertical profile 31b1 in such a way that it extends over the entire height of the window F.

The other branch 12F of the fixed wall 1F, advantageously the smallest, extends perpendicularly to the branch 11F, outside E the room L, in a vertical plane which is in the extension or parallel to the glass panel 4, opposite the latter. The branch 12F therefore does not cover the glass panel 4. The width of the branch 12F is for example between 5 cm and 10 cm.

The movable wall 1M is similar to the fixed wall 1F. It is integral with the opening frame 30, preferably integral with the vertical profile 30b1 of the opening frame 30. It is also formed by a profile of the corner or angle type, and has a cross-section in the shape of an L.

In FIGS. 8 and 10, one of the branches 11M of the movable wall 1M, advantageously the largest, forms a base which is attached to the vertical profile 30b1 of the opening frame 30. This attaching is carried out by any suitable means of fastening, in particular by screwing, snap-fitting, or gluing. The branch 11M forming a base has a width greater than that of the vertical profile 30b1, for example between 5 cm and 30 cm, in such a way that it extends inside and outside E the room L. Its length corresponds to that of the vertical profile 30b1 in such a way that it extends over the entire height of the window F. The branch 11M of the movable wall 1M is parallel to the branch 11F of the fixed wall 1F.

The other branch 12M of the movable wall 1M, advantageously the smallest, extends perpendicularly to the branch 11M, outside E the room L, in a vertical plane which is parallel to the glass panel 4, opposite the latter. The branch 12M therefore does not cover the glass panel 4. The width of the branch 12M is for example between 5 cm and 15 cm.

The branch 12M of the movable wall 1M is parallel to the branch 12F of the fixed wall 1F, but offset from the latter towards the outside E of the room L, for example by a distance between 2 cm and 15 cm. The separating of the branches 12M and 12F makes it possible to delimit the second end 12 of the ventilation passage 1, which end opens outside E the room L.

In relation to FIGS. 7 and 8, when the opening frame 30 is in the closed position, the walls 1F and 1M are close together. More particularly, the movable wall 1M is in tight contact with the fixed wall 1F over most of the length of said fixed wall. In practice, the branch 11M of the movable wall 1M comes into contact with the branch 11F of the fixed wall 1F. In this configuration, the ventilation passage 1 is hermetically closed in such a way that any ventilation between the inside and outside E the room L is prevented by said passage.

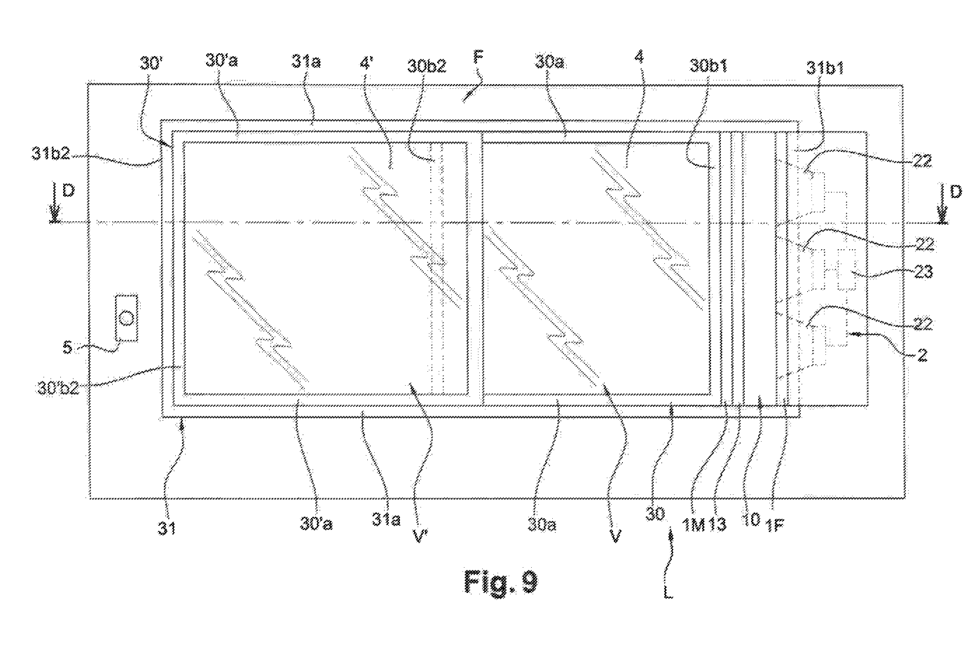

In the intermediate open position shown in FIGS. 9 and 10, the leaf V slides in such a way that the movable wall 1M moves away from the fixed wall 1F by a predetermined distance (for example between 2 cm and 15 cm, preferably 10 cm) and frees the ventilation passage 1. More particularly, the branch 11M moves away from the branch 11F. This distance, which corresponds to the sliding distance of the leaf V from the closed position to the intermediate open position, is for example between 2 cm and 15 cm. The branches 12M and 12F remain separated by the same distance as in the closed position.

In this intermediate open position, the ventilation passage 1 has its first end 10 that opens into the room L. This first end 10 is delimited on the one hand by the free end of the branch 11F of the fixed wall 1F, and on the other hand by the free end of the branch 11M of the movable wall 1M. The movable wall 1M and the fixed wall 1F are therefore in an arrangement that frees the ventilation passage 1 and that allows natural ventilation between the inside and outside E the room L by said ventilation passage, between the two ends 10 and 12. This ventilation is diagrammed in FIG. 9, by the arrow drawn in the passage 1.

The ends 10 and 12 of the ventilation passage 1 are located in two perpendicular vertical planes in such a way that said passage is in the shape of a chicane.

As such, in the closed position, the movable wall 1M closes the first end 10 and frees it in the intermediate open position. The second end 12 constantly remains freed.

In the embodiments of FIGS. 1, 2, 3, 4, 5, 6, 11, 12, 13 and 14, the closed off glazed surface corresponds substantially to the width of the fixed wall 1F. In the embodiment of FIGS. 7, 8, 9 and 10, the closed off glazed surface corresponds substantially to the combined thickness of the movable wall 1M and of the fixed wall 1F, with these two walls being interposed between the vertical profiles 30b1 and 31b1. Each one of these walls 1Mb and 1F has, in practice, a thickness of a few millimeters, for example between 2 mm and 5 mm. This results in that in the embodiment of FIGS. 7, 8, 9 and 10 the closed off glazed surface (between 4 mm and 10 mm) is less than the closed off glazed surface (between 5 cm and 30 cm) of the embodiments of FIGS. 1, 2, 3, 4, 5, 6, 11, 12, 13 and 14.

A noise absorber 2 is associated with the ventilation passage 1. This absorber is used for an active or passive control of the noise.

An active absorber 2 generates, in the ventilation passage 1, a sound level equivalent to the ambient sound level to be controlled, in particular a noise coming from a noise source located outside E the room L. In practice, this active absorber 2 generates a counter-noise which is superimposed on the sound waves propagating in the ventilation passage 1.

The active noise absorber 2 can have the form of a piezoelectric actuator or a loudspeaker. Preferably use is made of a linear loudspeaker of the type described in U.S. Patent document 6.285.773 (Carme) mentioned hereinabove, and to which those skilled in the art can refer where applicable. This type of linear loudspeaker can indeed be housed easily in a reduced volume and in particular in a narrow space, while still having an output comparable to that of a conventional loudspeaker with conical membranes. The geometrical shape and the particular arrangement of the elements that comprise the linear loudspeaker offer a very satisfactory output. In particular, in light of the substantial length of the membrane, the latter displaces a large mass of air during its vibration, which allows for good output in the low frequencies. This linear loudspeaker is for example installed vertically over the entire length of the fixed wall 1F or of the movable wall 1M.

The linear loudspeaker can however be replaced with several circular loudspeakers 22 installed side-by-side in the fixed wall 1F or in the movable wall 1M and in particular, in the case where the ventilation passage 1 is tiered, in each one of the channels. It is possible for example to use ASCA loudspeakers marketed by the applicant.

Use will be made in the rest of the description of the generic term loudspeaker, bearing the reference 22, whether the latter is a loudspeaker as such (circular or linear) or a piezoelectric actuator.

The noise absorber 2 can include a single linear loudspeaker or several circular loudspeakers 22 arranged on the fixed wall 1F or on the movable wall 1M. In order to simplify the design of the absorber 2 and its wiring, preference is however given to an installation on the fixed wall 1F. The choice of the number of loudspeakers and of their arrangement depends on the sound field to be attenuated, by superposition, of the noises propagating in the ventilation passage 1, in order to increase the sound insulation as soon as the window is in the intermediate open position.

In FIG. 11, the loudspeaker 22 comprises a membrane 220 suitable for vibrating and generating a counter-noise in the ventilation passage 1. An actuator 221 is associated with the membrane 220. This actuator 221 is adapted for inducing a vibratory movement to the membrane 220. This can be a piezoelectric actuator or more conventionally an actuator using an arrangement of magnets and a coil electrically excited to cause the vibration of the membrane 220 which generates the counter-noise.

At least one microphone 21 is installed in the ventilation passage 1 in order to sense the acoustic signals propagating in the latter. By way of example it is possible to use a microphone of the PUI Audio brand bearing the reference POM-2246L-C33-R and manufactured by the company PUI Audio.

The microphone 21 sends a signal that represents the noise in the ventilation passage 1 to a control electronics 23. Then, the control electronics 23 emits a control signal to the actuator 221 according to the acoustic signals sensed by the microphone 21. The absorber 2 as such makes it possible to increase the sound insulation of the window F when it is in the intermediate open position.

In a manner known to those skilled in the art, the control electronics 23 can implement a filtration by feedback and/or a filtration by feedforward. In the case of a filtration by feedback FEEDBACK, the microphone 21 is a control microphone, or of error. In the case of a filtration by feedforward FEEDFORWARD or in the case of a hybrid filtration FEEDBACK-FEEDFORWARD, the microphone 21 is an error microphone arranged in the vicinity of the first end 10 of the ventilation passage 1 and another reference microphone 24 (FIGS. 2, 3, 5, 6, 8, 10, 12) is provided arranged in the vicinity of the second end 12 of said passage. By way of example it is possible to use a reference microphone 24 of the PUI Audio brand bearing the reference POM-2246L-C33-R and manufactured by the company PUI Audio.

The assembly of FIG. 11 is that described in European patent EP0898774 (FRAUNHOFER) and the assembly of FIG. 12 is that described in American patent U.S. Pat. No. 6,963,647 (FRAUNHOFER), to which those skilled in the art can refer in case of need.

It is not necessary for the noise absorber 2 to be activated when the window F is in the closed position. To this effect, a switch is adapted to activate the noise absorber 2. In FIGS. 1, 4, 7 and 9, the switch 5 has the form of a rocker switch or a push-button installed in the room L, on a wall P, which switch is of the type conventionally used for lighting. By manipulating this switch 5, the user can activate or deactivate the noise absorber 2, for example by controlling the electrical power supply of the control electronics 23.

In an alternative embodiment, it is provided that the switch be controlled by the movement of the window F in such a way that when said window passes from the closed position to the intermediate open position, said switch automatically activates the active noise absorber 2. To this effect, a position sensor can be installed in the rail 31c. When the window is in the intermediate open position, the position sensor cooperates with the switch so that the latter automatically activates the active noise absorber 2. This switch can also be adapted to automatically deactivate the active noise absorber 2 when the window F is in the closed position or when it is not in the intermediate open position.

The absorber 2 can also be passive, i.e. it is adapted to absorb all or a portion of the sound waves propagating in the ventilation passage 1. To do this, the inner faces of the walls 1F and/or 1M which are located in the ventilation passage 1, can be partially or entirely covered with a sound-insulation material 13. In FIGS. 7 to 10, the inner face of the branch 11M of the movable wall 1M is covered with sound-insulation material 13. The inner face of the branch 12M can also be covered, as the inner face of the branch 11F and/or of the branch 12F of the fixed wall 1F.

In order to further improve the noise reduction in the ventilation passage 1, it is advantageous to combine an active attenuation through the use of the active absorber 2 and a passive attenuation by the covering of all or a portion of the inner faces of the movable wall 1M and/or of the fixed wall 1F.

In FIG. 15, the absorber 2 is passive. A flexible membrane 220 is simply suspended at the side walls of a cavity 223 arranged in the ventilation passage 1, for example on the fixed wall 1F. The membrane 220 closes the cavity 223 in such a way as to be able to vibrate in the ventilation passage 1. In this configuration, the membrane 220 absorbs all or a portion of the sound waves propagating in the ventilation passage 1, making it possible to increase the sound insulation. The membrane 220 is for example formed by a film with elastic properties, such as an elastomer having an elastic power or a polyethylene film.

The arrangement of the various elements and/or means and/or steps of the invention, in the embodiments described hereinabove, must not be understood as requiring such an arrangement in all of the implementations. In any case, it is understood that diverse modifications can be made to these elements and/or means and/or steps, without leaving the spirit and the scope of the invention. In particular:

The room L can be a particular compartment, such as the compartment of a motor vehicle, of a train, and even of an aircraft. The walls P are then for example formed from sheets.

The window F can include a single leaf V formed by the opening frame 30 mounted mobile in the stationary frame 31, or more than two leaves.

The two leaves V, V′ can be able to be displaced by laterally sliding in parallel planes on horizontal support rails mounted at the lower portion of the fixed stationary frame 31.

The leaf V can be displaced by vertically sliding over one or several vertical support rails mounted in the lateral portion of the stationary frame 31, and in particular in the vertical profiles 31b.

The frames 30 and 31 are preferably of rectangular or square shape, but can be of polygonal shape, have one or several curved edges, etc.

In the embodiment of FIGS. 1, 2, 3, 4, 5, 6, 11 and 12, the fixed wall 1F can be arranged in such a way that the branch 11F is in the same plane as the outer wall of the glass panel 4. In this case, the movable wall 1M is arranged in such a way that the branch 11M is in the same plane as the inner wall 4i of the glass panel 4.

In the embodiment of FIGS. 13 and 14, the fixed wall 1F can be made of glass or of plexiglas, and the noise absorber 2 installed on the movable wall 1M, in such a way as to not block out the transparency of the glass panel 4 in the closed position.

The absorber 2 can be installed inside the room L as well as outside E.

The natural ventilation in the passage 1 can be done from the outside of the room L towards the inside E; or from the inside of the room L to the outside E.

The element 310c forming an abutment can have any other form that suits those skilled in the art.

The ventilation passage 1 and the noise absorber 2 can be associated with a tilting window wherein the opening frame 30 is mounted movable in rotation in the stationary frame 31.

The assemblies of FIGS. 11, 12 and 15 apply regardless of the embodiment of the fixed 1F and movable 1M walls.

The ventilation passage 1 can be formed from several movable walls and/or from several fixed walls.

1-15. (canceled)

16. An apparatus for natural ventilation of a room, said apparatus comprising:
a room delimited by walls,
at least one door or one window installed in one of the room walls and comprising a fixed stationary frame surrounding an opening frame supporting a glass panel,
a ventilation passage provided on the door or the window and which communicates between the outside of the room and the inside of the room in such a way as to allow natural ventilation between the outside and inside of said room,
a noise absorber capable of attenuating sound waves propagating in the ventilation passage, the attenuation being realized by the generation of a counter-noise which is superimposed on said sound waves,
the opening frame is mounted movably in the stationary frame between:
a closed position wherein the opening frame is hermetically integral with the stationary frame in such a way as to prevent any ventilation between the inside and outside of the room by the door or the window,
and an open position wherein the open frame is detached and separated from the opening frame in such a way as to allow natural ventilation between the inside and outside of the room by the door or the window, wherein
the ventilation passage is delimited by at least one fixed wall and at least one movable wall, said fixed wall being integral with the stationary frame or with the wall and said movable wall being integral with the open frame,
the fixed wall and the movable wall are configured in such a way that:
when the opening frame is in the closed position, the movable wall and the fixed wall are in an arrangement that hermetically seals the ventilation passage and that prevents any ventilation between the inside and outside of the room by said ventilation passage,
when the opening frame is in the intermediate open position, the movable wall and the fixed wall are in an arrangement that frees the ventilation passage and that allows natural ventilation between the inside and outside of the room only by said ventilation passage.

17. The apparatus according to claim 16, wherein the fixed wall and the movable wall are formed by plates fixed respectively on the opening frame and on the stationary frame, said walls having inner faces which are located in the ventilation passage, at least one of these faces being covered partially or entirely with a sound-insulating material.

18. The apparatus according to claim 16, wherein:
the ventilation passage has a first end opening into the room and a second end opening to the outside of said room,
the fixed wall and the movable wall are configured in such a way that when the opening frame is in the closed position, the fixed wall closes the first end of the ventilation passage.

19. The apparatus according to claim 16, wherein:
the ventilation passage has a first end opening into the room and a second end opening to the outside of said room,
the fixed wall and the movable wall are configured in such a way that when the opening frame is in the closed position, the movable wall closes the second end of the ventilation passage.

20. The apparatus according to claim 16, wherein:
the fixed wall is integral with the stationary frame or with the wall and is formed by a profile that has a cross-section in the shape of an L of which one of the branches forms a base integral with a profile of said stationary frame,
the movable wall is symmetrical with the fixed wall, said movable wall is integral with the opening frame and is formed by a profile that has a cross-section in the shape of an L of which one of the branches forms a base integral with a profile of said opening frame.

21. The apparatus according to claim 16, wherein:
the fixed wall has the form of a flat plate integral with a profile of the stationary frame, said plate extending in a vertical plane which is in the extension of the glass panel, towards the latter,
the movable wall has the form of a flat plate integral with a profile of the opening frame, said plate extending in a vertical plane which is in the extension of the glass panel, opposite the latter.

22. The apparatus according to claim 21, wherein the plate forming the fixed wall and the inner wall of the glass panel are in the same plane, said plate covering said inner wall when the opening frame is in the closed position.

23. The apparatus according to claim 21, wherein the plate forming the movable wall and the outer wall of the glass panel are in the same plane, said plate covering the outer wall of the wall when the opening frame is in the closed position.

24. The apparatus according to claim 16, wherein the movable wall and the fixed wall of the ventilation passage are separated from one another, with this separation remaining constant from the closed position to the intermediate open position of the opening frame.

25. The apparatus according to claim 16, wherein the movable wall and the fixed wall are configured in such a way that when the opening frame is in the closed position, said movable wall is in tight contact with said fixed wall over most of the length of said fixed wall, in such a way that the ventilation passage is hermetically closed.

26. The apparatus according to claim 25, wherein when the opening frame is in the intermediate open position, the movable wall is separated from the fixed wall, in such a way that the ventilation passage is freed.

27. The apparatus according to claim 16, wherein when the opening frame is in the intermediate open position, the ventilation passage has the shape of a chicane.

28. The apparatus according to claim 16, wherein the opening frame is formed by profiles surrounding at least the glass panel, which opening frame is mounted able to slide in the fixed stationary frame, which stationary frame is provided with at least one rail whereon is displaced at least one of the profiles of said opening frame.

29. The apparatus according to claim 28, wherein the rail is provided with an element forming an abutment when the opening frame is in the intermediate open position.

30. A ventilation passage suitable for providing natural ventilation between the outside and the inside of a room, comprising:
at least one fixed wall and at least one movable wall, said fixed wall comprising means for fastening suitable for being attached to a stationary frame of a door or of a window or to a wall of the room and said movable wall comprising means for fastening suitable for being attached to a movable opening frame of said door or of said window, which fixed wall and which movable wall are configured in such a way that:
in a close-together position, the movable wall and the fixed wall are in an arrangement that prevents any ventilation by the ventilation passage,
in a separated position, the movable wall and the fixed wall are in an arrangement that allows natural ventilation only by the ventilation passage.
